(19) United States
(12) Patent Application Publication
(10) Pub. No.: US 2021/0144300 A1
(43) Pub. Date: May 13, 2021

(54) OMNIDIRECTIONAL PHOTOGRAPHING SYSTEM AND OMNIDIRECTIONAL PHOTOGRAPHING METHOD

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Shoichi KASHIWASE, Fujisawa Kanagawa (JP); Kenji OSAKI, Yokohama Kanagawa (JP); Tomomi HISHINUMA, Toshima Tokyo (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 17/123,164

(22) Filed: Dec. 16, 2020

Related U.S. Application Data
(63) Continuation of application No. PCT/JP2019/027694, filed on Jul. 12, 2019.

(30) Foreign Application Priority Data
Jul. 12, 2018 (JP) 2018-132399

(51) Int. Cl. H04N 5/232; H04N 5/225; H04N 7/18

(52) U.S. Cl. CPC H04N 5/23238; H04N 7/181; H04N 5/2258

(57) ABSTRACT

According to one embodiment, an omnidirectional photographing system comprising: at least two cameras, each of the two cameras being provided with a fisheye lens; a wearing tool that is to be worn by a wearer and is provided with the at least two cameras facing different directions; and an image processor configured to generate an entire celestial sphere image based on images generated by the at least two cameras, the entire celestial sphere image being an image that depicts surroundings of the wearer.

### CROSS-REFERENCE TO RELATED APPLICATIONS

This application is a Continuation Application of No. PCT/JP2019/027694, filed on Jul. 12, 2019, and the PCT application is based upon and claims the benefit of priority from Japanese Patent Application No. 2018-132399, filed on Jul. 12, 2018, the entire contents of which are incorporated herein by reference.

### TECHNICAL FIELD

Embodiments of the present invention relate to an omnidirectional photographing system and an omnidirectional photographing method.

### BACKGROUND

In a conventionally known technology, a helmet provided with a CCD camera is used for imaging the front area of a wearer who wears this helmet.

### PRIOR ART DOCUMENT

### Patent Document

[Patent Document 1] JP 2006-148842 A

### SUMMARY

### Problems to be Solved by Invention

The above-mentioned technology can image only the area in front of the wearer, and thus, the situation around the wearer cannot be grasped on the basis of the generated image. When the user wants to image the surroundings of the wearer, the wearer needs to look around the surroundings, and the work is interrupted, resulting in poor work efficiency. Accordingly, there is a demand for simultaneously imaging the surroundings of the wearer.

In view of the above-described circumstances, an object of embodiments of the present invention is to provide omnidirectional imaging technology that enables simultaneous imaging in all the directions around the wearer.

### Means for Solving Problem

In one embodiment of the present invention, an omnidirectional photographing system comprising: at least two cameras, each of the two cameras being provided with a fisheye lens; a wearing tool that is to be worn by a wearer and is provided with the at least two cameras facing different directions; and an image processor configured to generate an entire celestial sphere image based on images generated by the at least two cameras, the entire celestial sphere image being an image that depicts surroundings of the wearer.

### Effects of Invention

According to embodiments of the present invention, it is possible to provide omnidirectional imaging technology that enables simultaneous imaging in all the directions around the wearer.

### BRIEF DESCRIPTION OF DRAWINGS

FIG. 1 is a system configuration diagram illustrating an omnidirectional photographing system.

FIG. 2 is a block diagram illustrating the omnidirectional photographing system.

FIG. 3 is a front view illustrating a helmet.

FIG. 4 is a side view illustrating the helmet.

FIG. 5 is a schematic diagram illustrating an imaging range of cameras and a combined range of an entire celestial sphere image.

FIG. 6 is a schematic diagram illustrating an imaging range of the cameras when the helmet is viewed from directly above.

FIG. 7 is a schematic diagram illustrating an overhead-view image.

FIG. 8 is a flowchart illustrating an omnidirectional photographing method.

FIG. 9 is a schematic diagram illustrating the imaging range of the cameras when the helmet of a modification is viewed from directly above.

### DETAILED DESCRIPTION

Hereinbelow, embodiments of an omnidirectional photographing system will be described in detail by referring to the drawings. The reference sign 1 in FIG. 1 denotes an omnidirectional photographing system of the present embodiment.

As shown in FIG. 1 and FIG. 2, the omnidirectional photographing system 1 of the present embodiment includes: a wearing device 2 to be worn by each wearer W; and a management device 3 to be handled by a manager M who manages the wearer W. This omnidirectional photographing system 1 enables the manager M to monitor the surrounding condition of each wearer W who is working at a work site such as a nuclear plant and a factory, and thereby enables the manager M to give an appropriate instruction to each wearer W.

A description will be given of an aspect in which the manager M gives instructions from a remote location to a plurality of wearers W who perform work such as construction at the work site. The number of the wearers W may be one, and a plurality of managers M may monitor the wearers W by using a plurality of management devices 3.

Each wearer W works by wearing a working helmet 4 as a wearing tool. This helmet 4 is provided with two cameras 5, each of which includes a fisheye lens. The surroundings of the wearer W can be simultaneously imaged by these cameras 5. In other words, these two cameras 5 can simultaneously acquire images for generating an entire celestial sphere image that is a 360-degree panoramic (spherical) image of the wearer W in all the directions. Each image to be generated in the present embodiment may be a moving image or a still image.

Each wearer W wears a transmissive head mounted display 6 and a headset 7 so as to perform work. The helmet 4, the transmissive head mounted display 6, and the headset 7 constitute the wearing device 2. Each wearer W can work hands-free by wearing the wearing device 2.

The manager M handles a central computer 8 and monitors the situation of the surroundings of the wearers W while visually checking a display 9 connected to the central computer 8. On the display 9, the images generated by the cameras 5 of helmet 4 of each wearer W is displayed in real time.

The manager M also wears a headset 10 and instructs the wearers W. The central computer 8 is connected to a central wireless communication device 11 that performs wireless communication with the wearing devices 2 to be worn by the respective wearers W. The central computer 8, the display 9, the central wireless communication device 11, and the headset 10 constitute the management device 3.

Each of the headsets 7 and 10 to be worn by each wearer W and the manager M includes a microphone and a speaker. They can interact with each other via these headsets 7 and 10.

In addition, a wireless communication network may be configured between the wearing devices 2 and the central wireless communication device 11. Further, wireless communication maybe performed between the plurality of wearing devices 2. It should be noted that information regarding images generated by the cameras 5 is exchanged by wireless communication. When the wearers W work in an environment where wireless cannot be used, the wearing devices 2 and the central wireless communication device 11 may be connected by wire to perform communication.

Next, the system configuration of the omnidirectional photographing system 1 will be described by referring to the block diagram of FIG. 2.

Each wearing device 2 includes: a controller 12 configured to control this wearing device 2; two cameras 5, each of which includes a fisheye lens, provided in the helmet 4; a wearing-side image processor 13 that acquires the images generated by the cameras 5 and processes the acquired images; a wearing-side image display 14 that displays the images processed by the wearing-side image processor 13; a wearing-side image memory 15 that stores the images processed by the wearing-side image processor 13; a wireless communication unit 16 configured to perform wireless communication; and the headset 7.

The wearing-side image display 14 is a display screen mounted on the transmissive head mounted display 6. The wearing-side image processor 13, the wearing-side image memory 15, and the wireless communication unit 16 are mounted on a predetermined terminal (not shown) to be worn on the waist of each wearer W or the helmet 4. The wearing-side image processor 13 of the wearing device 2 is achieved by causing the CPU to execute the program stored in a memory or an HDD.

The management device 3 includes: a controller 17 configured to control this management device 3; a management-side image processor 18 that processes images acquired from the wearing devices 2; a management-side image display 19 that displays the images processed by the management-side image processor 18; a management-side image memory 20 that stores the images processed by the management-side image processor 18; a wireless communication unit 21 configured to communicate wirelessly with the wearing devices 2; and the headset 10.

The management-side image display 19 is a display screen mounted on the display 9. The wireless communication unit 21 is installed in the central wireless communication device 11. The controller 17, the management-side image processor 18, and the management-side image memory 20 are installed in the central computer 8. The management-side image processor 18 of the management device 3 is achieved by causing the CPU to execute the program stored in the memory or the HDD.

FIG. 3 is a front view showing the helmet 4. FIG. 4 is a side view showing the helmet 4. In the following description, the right side of the sheet of FIG. 4 is treated as the front side of the helmet 4.

As shown in FIG. 3 and FIG. 4, the helmet 4 has an approximately hemispherical shape and is to be worn on the head of the wearer W. On the outer peripheral surface of this helmet 4, the two cameras 5 with fisheye lenses are fixed to the right and left positions corresponding to temporal regions of the wearer W. That is, the two cameras 5 are placed apart with the helmet 4 in between. Since the helmet 4 is to be worn on the head of the wearer W, the two cameras 5 are placed apart with a body portion of the wearer W in between.

These cameras 5 are detachably attached to the outer peripheral surface of the helmet 4 via a helmet band 22 and attachments 23. In this manner, the cameras 5 can be provided on the helmet 4 for general work. In addition, when the cameras 5 are not needed, the cameras 5 can be removed from the helmet 4.

The two cameras 5 on the right and left are provided on the helmet 4 such that they face different directions. For example, in the camera 5 on the right side of the helmet 4, the center of the angle of view is directed to the right side, and in the camera 5 on the left side of the helmet 4, the center of the angle of view is directed to the left side. These cameras 5 are arranged so as to face in different directions, which are inverted by 180 degrees in the horizontal direction in plan view.

The cameras 5 are provided near a brim 24 of the helmet 4. It is preferred that the cameras 5 are provided within 10 cm above the brim 24. In this manner, the height position of the cameras 5 can be brought closer to the eye height position of the wearer W, and thus, an imaging range corresponding to the field of view of the wearer W can be secured.

Further, the cameras 5 are disposed in the portions excluding a crown of the helmet 4. In such disposition, if an obstacle that falls from above hits the helmet 4, direct hit of the obstacle against cameras 5 can be avoided. In addition, interference with objects around the helmet 4 is less likely to occur.

If the cameras 5 are placed close to each other and the entire circumference is imaged, the cameras 5 must be provided on the crown of the helmet 4 or the like. In this case, most of the angle of view of each camera 5 becomes the blind area of the wearer W and the imaging range becomes narrow. Further, for the manager M, the image of the line of sight of the wearer W cannot be obtained. The present embodiment can solve such problems.

The angle of view of each camera 5 with the fisheye lens according to the present embodiment is 180 degrees or more. For example, each camera 5 has an angle of view of 220 degrees or more. Preferably, each camera 5 has an angle of view of 235 degrees or more.

As shown in FIG. 5, the cameras 5 are positioned such that the center of the angle of view faces obliquely upward. For example, an imaging range L of the camera 5 on the left side and an imaging range R of the camera 5 on the right side overlap each other immediately above the helmet 4 (the wearer W).

In FIG. 5, the angle of view of each camera 5 is illustrated as 180 degrees. However, when the angle of view is 180 degrees or more, the center of the angle of view of each camera 5 does not necessarily have to point obliquely upward. For example, part of the vertical angle of view may overlap at the position directly above the helmet 4 by setting the angle of view to 220 degrees or more and positioning each camera 5 such that the center of this angle of view faces the horizontal direction.

In the present embodiment, an entire celestial sphere image depicting the surroundings of the wearer W is generated on the basis of the images generated by the right and left cameras 5. For example, the entire celestial sphere image is generated as a virtual imaging range S forming a sphere centered on a virtual point V at the position directly above helmet 4. That is, the images generated by the two cameras 5 are combined and converted into a spherical image centered on the virtual point V.

Specifically, the wearing-side image processor 13 (FIG. 2) acquires the images generated by the cameras 5. This wearing-side image processor 13 adjusts the curvature and size of the acquired images, and further, corrects the distortion of each partial image generated by the cameras 5 or the blurring of each image caused by motion of the wearer W. These corrected images are stitched together, and thereby, the entire celestial sphere image is automatically generated.

On the basis of the positional relationship between the cameras 5 and the wearer W, the curvature and size of the entire celestial sphere image are converted to generate an overhead-view image 25 (FIG. 7) that is an image obtained by imaging the wearer W from directly above the wearer W. Since the wearer W is not initially depicted in the overhead-view image 25, a head image of the wearer W or an auxiliary image corresponding thereto is automatically generated and combined with the overhead-view image 25.

The overhead-view image 25 generated by the wearing-side image processor 13 is displayed on the wearing-side image display 14. In this manner, each wearer W can grasp the surrounding situation on the basis of the images generated by the cameras 5. Further, the generated overhead-view image 25 may be transmitted to the management device 3.

In addition, the generated overhead-view image 25 is stored in the wearing-side image memory 15. In this manner, even if it is in the situation where the wearing device 2 cannot communicate with the outside, the images generated by the cameras 5 can be stored.

In the present embodiment, the overhead-view image 25 is also generated in the management-side image processor 18 of the management device 3. For example, the wearing-side image processor 13 (FIG. 2) acquires the images generated by the cameras 5 and then transmits the acquired images to the management device 3.

The management-side image processor 18 of the management device 3 adjusts the curvature and size of the acquired images, corrects the distortion or blurring of the images, automatically generates the entire celestial sphere image, and generates the overhead-view image 25 (FIG. 7) . The overhead-view image 25 generated by the management-side image processor 18 is displayed on the management-side image display 19. In this manner, the manager M can grasp the situation around the wearers W on the basis of the images generated by the cameras 5 and can give appropriate instructions to the wearers W.

Further, the generated overhead-view image 25 is stored in the management-side image memory 20. In this manner, the manager M can manage the images.

Although the present embodiment exemplifies an aspect in which the respective image processors 13 and 18 are provided in the wearing device 2 and the management device 3, the image processor 13 or 18 may be provided in either the wearing device 2 or the management device 3. For example, the weight of the wearing device 2 can be reduced by omitting the wearing-side image processor 13 in the wearing device 2, and thereby, the load on the wearer W is reduced. Further, when the management-side image processor 18 is not provided in the management device 3, only the image data having already been processed are transmitted to the management device 3, and thus, the amount of data to be transmitted can be reduced.

In the present embodiment, on the basis of the entire celestial sphere image, the image processors 13 and 18 generate the overhead-view image 25 as an image to be obtained by imaging the wearer W from directly above, and the overhead-view image 25 is displayed on the image displays 14 and 19. Thus, each wearer W or the manager M can grasp the situation around the wearer W on the basis of the images generated by the cameras 5.

FIG. 6 is a schematic diagram illustrating the imaging range of the cameras when the helmet 4 is viewed from directly above. In the following, the upper side of the sheet of FIG. 6 is treated as the front side of the helmet 4.

As shown in FIG. 6, when the respective cameras 5 are provided on the right and left sides of the helmet 4, part of the angles of view of the respective cameras 5 overlap each other. For example, when each camera 5 has a fisheye lens that has a horizontal angle of view of 235 degrees, the imaging ranges L and R of the right and left cameras 5 overlap in a front area F and a back area B of the wearer W. That is, a plurality of cameras 5 are provided in the helmet 4 in such a number that the number of these cameras 5 are sufficient for imaging the entire surrounding of the wearer W in the horizontal direction. In this manner, the entire celestial sphere image can be generated on the basis of the images obtained by imaging the entire surrounding of the wearer W in the horizontal direction.

In the present embodiment, the positions of the right and left cameras 5 are fixed by the helmet 4. That is, a distance K between the right and left cameras 5 is fixed by the helmet 4. When there is a predetermined subject 26 in the front area F of the wearer W, the position of the image of the subject 26 imaged by each camera 5, i.e., the direction D1 of the left camera 5 with respect to the subject 26 and the direction D2 of the right camera 5 with respect to the subject 26 are obtained. Further, the distance from the wearer W to the subject 26 can be obtained on the basis of the distance K between the right and left cameras 5 and the directions D1 and D2 with respect to the subject 26. The distance K is preferably in the range of 5 cm or more and 20 cm or less.

The image processors 13 and 18 (FIG. 2) calculate the distance from the wearer W to the subject 26 on the basis of the images of the subject 26 having been imaged by the cameras 5 and the distance K between the cameras 5. In this manner, the distance from the wearer W to the subject 26 can be grasped on the basis of the information on the cameras 5.

The distance from the wearer W to the subject can be calculated even when the predetermined subject is present not only in the front area F of the wearer W but also in the back area B. That is, when the subject is positioned in the area where the respective imaging ranges L and R of the two cameras 5 overlap, the distance from the wearer W to the subject can be determined.

In addition, when there is a dangerous object as a subject within a predetermined range centered on the wearer W, notification output may be outputted to warn the wearer W or the manager M.

The display 9 to be visually recognized by the manager M maybe configured as a three-dimensional display that can display a stereoscopic image. In this case, the display 9 may display a stereoscopic image, which depicts the subject 26 and is a stereoscopic image obtained by using the parallax of the right and left cameras 5.

In the present embodiment, the two cameras 5 having an angle of view of 180 degrees or more are provided at the respective positions corresponding to the temporal regions of the wearer W, and thus, the front area F or the back area B of the wearer W can be imaged by the two cameras 5. Hence, three-dimensional information such as the distance of the subject 26 existing in the front area F or the back area B can be obtained on the basis of the generated images. In particular, an image, by which the front area F such as a hand area H of the wearer W can be stereoscopically viewed, can be generated. In addition, imaging can be performed from a position close to the viewpoint of the wearer W.

As shown in FIG. 7, the overhead-view image 25 includes supplementary information 29 indicating the distance from the wearer W to the subject 27. For example, the manager M can give appropriate instructions to the wearers W on the basis of the supplementary information 29.

In addition, when a reference subject 28 that is a reference is depicted in the overhead-view image 25, the image processors 13 and 18 can calculate the position of the wearer W on the basis of the reference subject 28 on the screen. Further, the movement track of the wearer W can be calculated by continuously storing the positions of the wearer W.

Moreover, when the other wearer W is depicted in the overhead-view image 25 of one wearer W, on the basis of the other wearer Won the screen, the image processors 13 and 18 can calculate the position of the other wearer W assuming that the position of the one wearer W is the center. Furthermore, when the position of the one wearer W is known, the position of the other wearer W can be calculated. In addition, the movement track of the other wearer can be calculated by continuously storing the positions of the other wearer W. The other wearer W may be a person who does not wear the wearing device 2.

Each wearer W can grasp the surrounding situation by visually observing the wearing-side image display 14 of the transmissive head mounted display 6. In addition, even when the wearer W wears a protective mask and the field of view is narrowed, the surrounding situation can be accurately grasped.

The manager M can grasp the situation around the wearers W who work in a remote place by visually recognizing the management-side image display 19 of the display 9 and can give the wearers W accurate instructions.

Next, a description will be given of the omnidirectional photographing method to be executed by the omnidirectional photographing system 1 on the basis of the flowchart of FIG. 8 by referring to the block diagram of FIG. 2 as required.

This processing is repeated at regular intervals. The omnidirectional photographing system 1 executes the omnidirectional photographing method by repeating this processing. Note that this processing may be executed while the omnidirectional photographing system 1 is executing other main processing.

As shown in FIG. 8, first, in the step S11, each wearer W wears the wearing device 2 including the helmet 4 on which a plurality of cameras 5 with fisheye lenses are provided so as to face different directions.

In the next step S12, the surroundings of each wearer W is simultaneously imaged by using the plurality of cameras 5 provided on the helmet 4.

In the next step S13, the wearing-side image processor 13 of the wearing device 2 acquires the images generated by the cameras 5. Additionally or alternatively, the management-side image processor 18 of the management device 3 acquires the images generated by the camera 5 from the wearing device 2.

In the next step S14, the wearing-side image processor 13 or the management-side image processor 18 adjusts the curvature and size of the acquired images and corrects the distortion or blurring of the acquired images.

In the next step S15, the wearing-side image processor 13 or the management-side image processor 18 generates an entire celestial sphere image that depicts the surroundings of the wearer W on the basis of the images generated by the cameras 5.

In the next step S16, the wearing-side image processor 13 or the management-side image processor 18 converts the curvature and size of the entire celestial sphere image so as to generate an overhead-view image that depicts the wearer W viewed from directly above the wearer W.

In the next step S17, the wearing-side image display 14 of the wearing device 2 or the management-side image display 19 of the management device 3 displays the overhead-view image.

In the next step S18, the wearing-side image processor 13 or the management-side image processor 18 calculates the distance from the wearer W to the subject 27 on the basis of the images of the subject 27 generated by the cameras 5 and the distance K between the cameras 5.

In the next step S19, the wearing-side image display 14 or the management-side image display 19 displays supplementary information 29 indicative of the distance from the wearer W to the subject 27.

In the next step S20, the wearing-side image memory 15 of wearing device 2 or the management-side image memory 20 of management device 3 stores the overhead-view image.

Since the wearing tool of the present embodiment is the helmet 4 to be worn by each wearer W, each wearer W can readily wear the wearing tool. In addition, each wearer W can work hands-free, and the cameras 5 to be installed in it does not interfere with the work.

Further, the distortion of each partial image generated by the cameras 5 or the blurring caused by motion of the wearers W is corrected, and thus, visually-induced motion sickness (i.e., 3D sickness) of the person viewing the images can be prevented.

Since each camera 5 to be used is provided with a fisheye lens, the number of cameras 5 to be mounted on the helmet 4 can be reduced. Thus, the weight of the helmet 4 can be reduced. Furthermore, the manufacturing cost of the wearing device 2 can be reduced.

Next, a helmet 4 as a modification will be described. FIG. 9 is a schematic diagram illustrating the imaging range of the camera when the helmet 4 is viewed from directly above. In the following description, the upper side of the sheet of FIG. 9 is treated as the front side of the helmet 4.

As shown in FIG. 9, in the helmet 4 of the modification, the cameras 5, each of which is provided with a fisheye lens, are provided at respective three locations including the front portion, the left rear portion, and the right rear portion. The angle of view of each of these three cameras 5 is 180 degrees. The arrangement of the three cameras 5 is rotationally symmetric so as to be separated by 120 degrees from each other around the helmet 4 in plan view.

In this modification, the imaging range of each camera 5 overlaps in a front left area Q1, a front right area Q2, and a back area Q3 of the wearer W. That is, the helmet 4 is provided with sufficient number of the cameras 5 for imaging the entire surrounding of the wearer Win the horizontal direction. In this manner, even if each camera 5 to be used has a fisheye lens with a narrow angle of view, the entire surrounding of the wearer W in the horizontal direction can be imaged.

The omnidirectional photographing system in the above-described embodiments includes hardware resources such as a Central Processing Unit (CPU), a Read Only Memory (ROM), a Random Access Memory (RAM), and a Hard Disc Drive (HDD), and is configured as a computer in which information processing by software is achieved with the use of the hardware resources by causing the CPU to execute various programs. Further, the omnidirectional photographing method in the above-described embodiments is achieved by causing the computer to execute the various programs.

Although a mode in which each step is executed in series is illustrated in the flowcharts of the above-described embodiments, the execution order of the respective steps is not necessarily fixed and the execution order of part of the steps may be changed. Additionally, some steps may be executed in parallel with another step.

The system in the above-described embodiments includes a storage device such as a Read Only Memory (ROM) and a Random Access Memory (RAM), an external storage device such as a Hard Disk Drive (HDD) and a Solid State Drive (SSD), a display device such as a display panel, an input device such as a mouse and a keyboard, a communication interface, and a control device which has a highly integrated processor such as a special-purpose chip, a Field Programmable Gate Array (FPGA), a Graphics Processing Unit (GPU), and a Central Processing Unit (CPU). The system can be achieved by hardware configuration with the use of a normal computer.

Note that each program executed in the system in the above-described embodiments is provided by being incorporated in a memory such as a ROM in advance. Additionally or alternatively, each program may be provided by being stored as a file of installable or executable format in a non-transitory computer-readable storage medium such as a CD-ROM, a CD-R, a memory card, a DVD, and a flexible disk (FD).

In addition, each program executed in the system may be stored on a computer connected to a network such as the Internet and be provided by being downloaded via a network. Further, the system can also be configured by interconnecting and combining separate modules, which independently exhibit respective functions of the components, via a network or a dedicated line.

Although the management-side image display 19 is the display screen of the display 9 in the above-described embodiments, another aspect may be adopted. For example, the management-side image display 19 may be a display screen mounted on a non-transmissive head-mounted display. In this case, the manager M may wear this non-transmissive head-mounted display so that the entire celestial sphere image depicting the surroundings of the wearer W can be visually recognized.

Although the cameras 5 are provided on the outer peripheral surface of the helmet 4 in the above-described embodiments, the cameras 5 may be provided at other positions. For example, the cameras 5 may be provided on the lower face side of the brim 24 of the helmet 4 so that the surroundings of the wearer W can be imaged. In this manner, the cameras 5 do not get wet when the worker works in the rain, and the cameras 5 are prevented from being damaged when the helmet 4 hits an obstacle.

Although the helmet 4 is illustrated as the wearing tool in the above-described embodiments, other wearing tools may be used. For example, the cameras 5 may be provided on an object to be worn on the head such as a hat, glasses, goggles, a head-mounted display, and a protective mask so that the surroundings of the wearer W can be imaged.

Although the entire celestial sphere image is first generated from the images generated by the camera 5 and then an overhead-view image 25 is generated on the basis of this entire celestial sphere image in the above-described embodiments, other aspects may be adopted. For example, the overhead-view image 25 maybe generated on the basis of the images generated by the cameras 5 without generating the entire celestial sphere image.

Although two or three cameras 5 are provided on the helmet 4 in the above-described embodiments, four or more cameras 5 may be provided on the helmet 4.

Although the manager M monitors the surroundings of the wearers W such that manager M can give accurate instructions to the wearers W in the above-described embodiments, other aspects may be adopted. For example, the management device 3 provided with artificial intelligence (AI) may monitor the surrounding conditions of the wearers W such that this artificial intelligence can give accurate instructions to the wearers W. In addition, the wearing device 2 provided with artificial intelligence may monitor the surrounding conditions of the wearers W and give instructions.

In the image analysis using the computer of the above-described embodiments, an analysis technique based on learning of AI can be used. For example, a learning model generated by machine learning using a neural network, a learning model generated by other machine learning, a deep learning algorithm, or a mathematical algorithm such as regression analysis can be used. In addition, forms of machine learning include forms such as clustering and deep learning.

The omnidirectional photographing system 1 of the above-described embodiments includes the computer having AI that performs machine learning. For example, the system may be configured by a single computer that includes the neural network or the system may be configured by a plurality of computers including the neural network.

The above-described neural network is a mathematical model that expresses the characteristics of brain functions by computer simulation. For example, artificial neurons (nodes) that form a network through synaptic connections change the synaptic connection strength through learning and show a model that has acquired problem-solving ability. Furthermore, the neural network acquires problem-solving ability by deep learning.

For example, the neural network is provided with intermediate layers composed of six layers. Each layer of the intermediate layers is composed of, for example, 300 units. In addition, feature amount in a pattern of change in state of a circuit or system can be automatically extracted by causing a multilayer neural network to learn in advance with the use of learning data. On the user interface, the multilayer neural network can set arbitrary number of intermediate layers, arbitrary number of units, arbitrary learning rate, arbitrary number of times of learning, and arbitrary activation function.

The neural network may use deep reinforcement learning in which a reward function is set for each of various information items to be learned and the information item with the highest value is extracted from the various information items on the basis of the reward function.

For example, a Convolution Neural Network (CNN) that has a proven performance in image recognition is used. In this CNN, the intermediate layer is composed of a convolution layer and a pooling layer. The convolution layer obtains a feature map by applying filtering processing to nearby nodes in the previous layer. The pooling layer further reduces the feature map outputted from the convolution layer so as to generate a new feature map. A slight deviation of the image can be absorbed by depending on which value of a target region.

The convolution layer extracts local features of the image, and the pooling layer performs processing of integrating or aggregating the local features. In the processing to be executed by the convolution layer and the pooling layer, the image is reduced in size while maintaining the features of the input image. That is, the CNN can greatly compress (abstract) the amount of information of image. Further, the input image can be recognized and the image can be classified by using the abstracted image stored in the neural network.

In deep learning, there are various methods such as an auto encoder, a Recurrent Neural Network (RNN), a Long Short-Term Memory (LSTM), and a Generative Adversarial Network (GAN). These methods may be applied to the deep learning of the above-described embodiments.

According to the above-described embodiments, the wearing tool to be worn by each wearer includes at least two cameras, which are provided with fisheye lenses and are placed so as to face different directions, and thus, it enables simultaneous imaging in all the directions around the wearer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### REFERENCE SIGNS LIST

1 . . . omnidirectional photographing system, 2 . . . wearing device, 3 . . . management device, 4 . . . helmet, 5 . . . camera, 6 . . . head mounted display, 7 . . . headset, 8 . . . central computer, 9 . . . display, 10 . . . headset, 11 . . . central wireless communication device, 12 . . . controller, 13 . . . wearing-side image processor, 14 . . . wearing-side image display,15 . . . wearing-side image memory, 16 . . . wireless communication unit, 17 . . . controller, 18 . . . management-side image processor, 19 . . . management-side image display, 20 . . . management-side image memory, 21 . . . wireless communication unit, 22 . . . helmet band, 23 . . . attachment, 24 . . . brim, 25 . . . overhead-view image, 26,27 . . . subject, 28 . . . reference subject, 29 . . . supplementary information, B . . . back area, D1,D2 . . . direction with respect to the subject, F . . . front area, K . . . distance between cameras, L . . . imaging range of the left camera, M . . . manager, Q1 . . . front left area, Q2 . . . front right area, Q3 . . . back area, R . . . imaging range of the right camera, S . . . virtual imaging range, V . . . virtual point, W . . . wearer.

1. An omnidirectional photographing system comprising:
at least two cameras, each of the two cameras being provided with a fisheye lens;
a wearing tool that is to be worn by a wearer and is provided with the at least two cameras facing different directions; and
an image processor configured to generate an entire celestial sphere image based on images generated by the at least two cameras, the entire celestial sphere image being an image that depicts surroundings of the wearer.

2. The omnidirectional photographing system according to claim 1, wherein:
the at least two cameras point in different directions in a horizontal direction;
an angle of view of each of the at least two cameras partially overlap each other; and
number of the at least two cameras is sufficient for imaging an entire surrounding of the wearer in the horizontal direction.

3. The omnidirectional photographing system according to claim 1, wherein the image processor is configured to generate an overhead-view image based on the entire celestial sphere image, the overhead-view image being an image obtained by imaging the wearer from directly above.

4. The omnidirectional photographing system according to claim 1, wherein:
positions of the at least two cameras are fixed by the wearing tool; and
the image processor is configured to calculate distance from the wearer to a subject based on an image of the subject having been imaged by the at least two cameras and distance between the at least two cameras.

5. The omnidirectional photographing system according to claim 1, wherein:
the wearing tool is mounted on a head of the wearer; and
each of the at least two cameras has an angle of view of 180 degrees or more and is provided at a position corresponding to temporal regions of the wearer.

6. The omnidirectional photographing system according to claim 1, wherein the wearing tool is a helmet to be worn by the wearer.

7. The omnidirectional photographing system according to claim 1, further comprising a management-side image display that is provided in a management device and can display an image generated by the image processor,
wherein the management device is configured to acquire images generated by the at least two cameras by wireless communication.

8. The omnidirectional photographing system according to claim 7, wherein the management device or a manager managing the wearer can grasp a surrounding situation of the wearer based on the image generated by the image processor.

9. The omnidirectional photographing system according to claim 8, further comprising a communication device for the management device or the manager to send an instruction to the wearer.

10. The omnidirectional photographing system according to claim 7, wherein the image processor is provided in the management device.

11. The omnidirectional photographing system according to claim 1, further comprising a wearing-side image display that is provided in the wearing tool and can display an image generated by the image processor.

12. The omnidirectional photographing system according to claim 1, wherein the image processor is provided in a wearing device to be worn by the wearer.

13. The omnidirectional photographing system according to claim 1, further comprising a wearing-side image memory that is provided in the wearing tool and stores images generated by the at least two cameras.

14. An omnidirectional photographing method comprising:
making a wearer wear a wearing tool that is provided with at least two cameras, the at least two cameras being disposed to face different directions and provided with fisheye lenses; and
generating an entire celestial sphere image based on images generated by the at least two cameras, the entire celestial sphere image being an image that depicts surroundings of the wearer.
